(19) United States
(12) Patent Application Publication
(10) Pub. No.: US 2013/0297461 A1
(43) Pub. Date: Nov. 7, 2013

(54) METHOD, SYSTEM AND APPARATUS FOR INTEGRATING ORDER MANAGEMENT AND WAREHOUSE MANAGEMENT

(71) Applicants: Kevin Nelson WONG, Toronto (CA); Daniel A. Teoh, Hamilton (CA); Emily A. Stover, Toronto (CA); Enam Rabbani, Toronto (CA); Jason A. Yuen, Toronto (CA); Sean S. Kirby, Toronto (CA); Jessica S. Liu, Toronto (CA); Mehran Malek, Toronto (CA); Bryce Kwan, Ajax (CA)

(72) Inventors: Kevin Nelson WONG, Toronto (CA); Daniel A. Teoh, Hamilton (CA); Emily A. Stover, Toronto (CA); Enam Rabbani, Toronto (CA); Jason A. Yuen, Toronto (CA); Sean S. Kirby, Toronto (CA); Jessica S. Liu, Toronto (CA); Mehran Malek, Toronto (CA); Bryce Kwan, Ajax (CA)

(73) Assignee: NULOGY CORPORATION, Toronto (CA)

(21) Appl. No.: 13/462,178

(22) Filed: May 2, 2012

(51) Int. Cl. G06Q 10/08

(52) U.S. Cl. CPC G06Q 10/087
USPC 705/28

(57) ABSTRACT

According to embodiments described in the specification, a method, system and apparatus for integrating warehouse management and order management are provided. The method comprises: maintaining, in a memory connected to a first server, a first data store comprising a plurality of records representing one or more items at a production site; detecting an event at the first server, the event comprising an update to the first data store; in response to detecting the event, determining whether a further action is required to send at least one outgoing message to one or more of a second server and a third server; and, when the determination is affirmative, generating a the outgoing message and transmitting the message to the one or more of the second server and the third server.

### FIELD

The specification relates generally to inventory management, and specifically to a method, system and apparatus for integrating order management and warehouse management.

### BACKGROUND

The production of goods often involves a plurality of entities, sites, and computing systems. For example, an order may be generated by one entity using a certain software package, carried out by a second entity which uses another software package to monitor production activities, and the completed goods may be stored by a third entity using yet another software package to manage the storage warehouse.

As a result, exchanges of data between entities can be inefficient, inaccurate, and introduce process lag, for example by requiring manual entry of data. Such exchanges can increase the likelihood of the various entities storing mismatched and incorrect records.

The above challenges are amplified when the manufacturing entity, such as a contract packager, must interact with a plurality of ordering entities and storing entities.

### BRIEF DESCRIPTIONS OF THE DRAWINGS

Non-limiting example embodiments are described with reference to the following figures, in which:

FIG. 1 depicts a system for integrating warehouse and order management, according to a non-limiting embodiment;

FIG. 2 depicts a method for integrating warehouse and order management, according to a non-limiting embodiment;

FIG. 3 depicts a method for integrating warehouse and order management, according to an addition non-limiting embodiment;

FIG. 4 depicts a performance of block 305 of the method of FIG. 3, according to a non-limiting embodiment;

FIG. 5 depicts a performance of block 325 of the method of FIG. 3, according to a non-limiting embodiment;

FIG. 6 depicts a performance of block 340 of the method of FIG. 3, according to a non-limiting embodiment;

FIG. 7 depicts a system for integrating warehouse and order management, according to another non-limiting embodiment;

FIG. 8 depicts interfaces provided by the co-packer server of FIG. 1 to a computing device connected to the co-packer server, according to a non-limiting embodiment; and

FIG. 9 depicts further interfaces provided by the co-packer server of FIG. 1 to a computing device connected to the co-packer server, according to a non-limiting embodiment.

### DETAILED DESCRIPTION

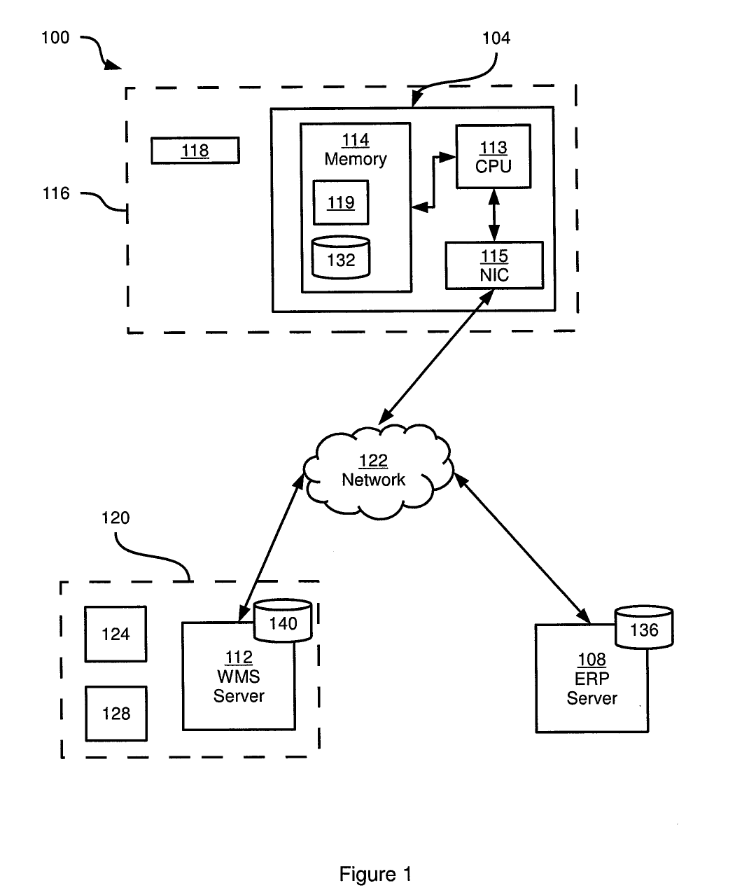

FIG. 1 depicts a system 100 for integrating warehouse management and order management. System 100 includes a contract packager (co-packer) server 104 (also referred to as server 104), an enterprise management server 108 (also referred to as an enterprise resource planning (ERP) server 108, or as server 108) and a warehouse management system (WMS) server 112 (also referred to as server 112).

In the example shown in FIG. 1, server 104 includes a central processing unit (CPU) 113, also referred to herein as processor 113, interconnected with a non-transitory computer readable storage medium such as a memory 114. Memory 114 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. Memory 114 also maintains a plurality of computer-readable instructions executable by processor 113. Such instructions include, for example, an operating system and one or more applications, as will be discussed below. Processor 113, via execution of the instructions contained within the application operating system and applications, is configured to carry out various actions, as will be discussed below. It is contemplated that the applications can be maintained on other non-transitory computer readable media than memory 113, such as optical media, flash media and the like.

Server 104 can also include input and output devices interconnected with processor 108, such as a keyboard, a mouse, a display and the like (not shown). It is contemplated that other input and output devices can also be used with server 104, including, for example, touch screens, speakers, microphones and the like. In some examples (not shown), the input and output devices can be co-located with server 104 and connected with processor 113 via, for example, one or more universal serial bus (USB) links, while in other examples, input and output devices can be located remotely at an additional terminal, such as a personal computer connected with server 104. Such a terminal can be located within the same facility as server 104, or in a different facility accessible via a network.

Server 104 also includes a network interface controller (NIC) 115, also referred to herein as a communications interface, for connecting server 104 to a network, discussed in further detail below, via any suitable combination of wired and wireless links.

Co-packer server 104 is associated with a contract packager production site 116 comprising at least one production line 118 for converting subcomponents into finished goods. Co-packer server 104 is contemplated as being physically located at production site 116 in the present example, as seen in FIG. 1. However, server 104 can also be located remotely from production site 116. As will be discussed in greater detail below, co-packer server 104 stores and processes data representing activities at production site 116, and also receives and transmits messages to and from each of WMS server 112 and ERP server 108 via a network 122. Network 122 can include any suitable combination of wired and/or wireless networks, including but not limited to a WAN such as the Internet, a Local Area Network (“LAN”), cell phone networks, WiFi networks, WiMax networks and the like.

Server 104 maintains, in memory 114, a plurality of computer readable instructions in the form of an application 119 stored in memory 114 (or in other computer readable media, as discussed above). Processor 113 is configured to execute the instructions of application 119, and thereby to perform various functions, as will be discussed below in greater detail.

ERP server 108 can be associated with an entity such as a customer of production site 116 and a warehouse site 120, and therefore stores and processes data representing order management, materials management, accounting and production planning. ERP server 108 also transmits messages to co-packer server 104 and receives messages from co-packer server 104 via network 122.

WMS server 112 is associated with warehouse site 120. Warehouse site 120 comprises storage locations for physical goods such as the subcomponents 124 and finished goods 128 (generally referred to herein as “items”) mentioned above in connection with production site 116. Although WMS server 112 is contemplated as being physically located at warehouse site 120 in the present example, in other examples WMS server 112 can be located remotely from warehouse site 120. WMS server 112 receives messages from and transmits messages to co-packer server 104 via network 122. It is contemplated that warehouse site 120 can be either co-located with production site 116 (for example in the same facility), or located remotely from production site 116.

ERP server 108 and WMS server 112 are each based on any suitable server architecture, and can therefore each include one or more processors interconnected with memories and housed in enclosures.

In general, the entity associated with ERP server 108, referred to herein as the customer, generates orders for co-packer production site 116. Such orders may request the production of a certain quantity of a certain type of finished good 128. Server 108 can therefore be configured to execute enterprise management software, such as SAP ERP™. Production site 116, in turn, converts subcomponents 124 into finished goods 128 at production line 118 in accordance with the orders generated by server 108. Warehouse site 120, meanwhile, is a repository for subcomponents 124 to be used at production site 116 and finished goods 128 produced at site 116. WMS server 112 can therefore be configured to execute warehouse management software, such as RedPrairie™. It is contemplated that server 108 can execute any suitable enterprise management or ordering software other than, or in addition to, SAP ERP™, and that server 112 can execute any suitable warehouse management software other than, or in addition to, Red Prairie™.

Each of servers 104, 108 and 112 maintain respective data stores. The data store 132 of server 104, stored in memory 114, comprises records representing one or more inventory items. More specifically, data store 132 can comprise records representing levels (e.g. quantities) of physical inventory (that is, of subcomponents 124 and finished goods 128) located at production site 116, as well as identifying information for that inventory. Such identifying information can include item identifiers, locations within site 116, associations with production jobs, lot numbers, expiry dates, origin and destination identifiers (for example, subcomponents 124 may originate at site 120, while finished goods 128 may be destined for warehouse site 120 or for a different warehouse site, not shown). Table 1 contains simplified example data records representing levels of inventory. Thus, 1000 units of subcomponent 124 are present at site 116 in a storage location, while an additional 200 units of subcomponent 124 are present at production line 118, for use in a job (with the identifier “1234”). Further, 100 units of finished good 128 are present at production line 118, having been produced in the same job mentioned above. Still further, 500 units of subcomponent 124 are incoming from warehouse site 120 to be used in the job 1234, for example in response to a request from server 104 to server 112.

TABLE 1
Data Store 132 Inventory Records

| Item ID | Quantity | Location | Job |
|---|---|---|---|
| 124 | 1000 | Storage | 2256 |
| 124 | 200 | Line 118 | 1234 |
| 128 | 100 | Line 118 | 1234 |
| 124 | 500 | Incoming-120 | 1234 |

Data store 132 can also include records defining various transactions, such as movements of inventory within production site 116, for example when a certain quantity of subcomponent 124 is physically moved from on-site storage to production line 118 for consumption in a job. Data store 132 also comprises records representing jobs (that is, conversions of subcomponents 124 into finished goods 128), both planned (i.e. not yet performed) and historical (i.e. already performed). Such job records include job identifiers, identifiers of the subcomponents 124 used, or to be used, and of the finished goods 128 produced, or to be produced. Table 2 contains a simplified example data record representing a job having the identifier “1234”, for which an order was received from ERP server 108.

TABLE 2
Data Store 132 Job Records

| | | Item ID | | Expected |
|---|---|---|---|---|
| Job ID | Customer | Produced | Quantity | Delivery Date |
| 1234 | ERP 108 | 128 | 200 | Jun. 1, 2012 |

The data store 136 of server 108 comprises records representing levels of physical inventory located at production site 116 and warehouse site 120. As mentioned above in connection with data store 132, various additional information (such as lot codes and the like) can also be stored in data store 136. Data store 136 also includes data records representative of orders for jobs to be performed at production site 116. Table 3, below contains simplified example data records representing levels of inventory. Data store 136 can also include data records representing orders, such as those transmitted to production site 116 (not shown in Table 3).

TABLE 3
Data Store 136 Data Records

| Item ID | Quantity | Location |
|---|---|---|
| 124 | 1200 | Site 116 |
| 128 | 100 | Site 116 |
| 124 | 10000 | Site 120 |

The data store 140 of server 112 comprises records representing levels of inventory at warehouse site 120. As discussed above in connection with data stores 132 and 136, such records can also therefore include lot numbers, expiry dates, origin and destination identifiers, quantities and the like. Table 4 shows a simplified example data record representing inventory levels at site 120. The data records in data store 140 can include additional data, such as the “owner” of the inventory (the operating entity of ERP server 108, in the present example). Other example data that can be included in the records of data store 140 are status and destination indicators. A status indicator indicates whether inventory is free for use in newly received requests, or reserved to satisfy an existing request. A destination indicator identifies the location to which reserved inventory is to be transferred, or is currently being transferred. In some examples, where sites 116 and 120 are located within the same facility, destination identifiers and other transportation-related information (such as weights, lading numbers, and the like) can be omitted.

TABLE 4
Data Store 140 Data Records

| Item ID | Quantity | Status | Destination |
|---|---|---|---|
| 124 | 500 | Reserved | Site 116 |
| 124 | 9500 | Free | N/A |

It can therefore be seen that the contents of data stores 132, 136 and 140 overlap to a certain degree. For example, data store 136 at ERP server 108 can include representations of the total quantity of subcomponent 124 at warehouse site 120, and the total quantity of subcomponent 124 at production site 116. Meanwhile, data store 132 can include a representation of the total quantity of subcomponent 124 at production site 116, and data store 140 can include a representation of the total quantity of subcomponent 124 at warehouse site 120.

The above-mentioned overlap between data stores 132, 136 and 140 occurs because the activities at production site 116 (managed by server 104), warehouse site 120 (managed by server 112) and ERP server 108 relate to the same physical goods. That is, the customer entity operating server 108 may own the inventory at warehouse site 120 and production site 116, and is also responsible for setting production schedules at site 116 and other production sites (not shown) and predicting required inventory levels at production and warehouse sites. Those production schedules may involve various movements of inventory between production site 116 and warehouse site 120. In the example records in Tables 1-4 above, the contents of data stores 132, 136 and 140 together represent the physical movements and locations of the same 11200 units of subcomponent 124 and 100 units of finished good 128.

As will be discussed in greater detail below, co-packer server 104 is configured to send and receive messages via network 122 to and from ERP server 108 and WMS server 112, thereby updating one or both of data stores 136 and 140 in response to various events.

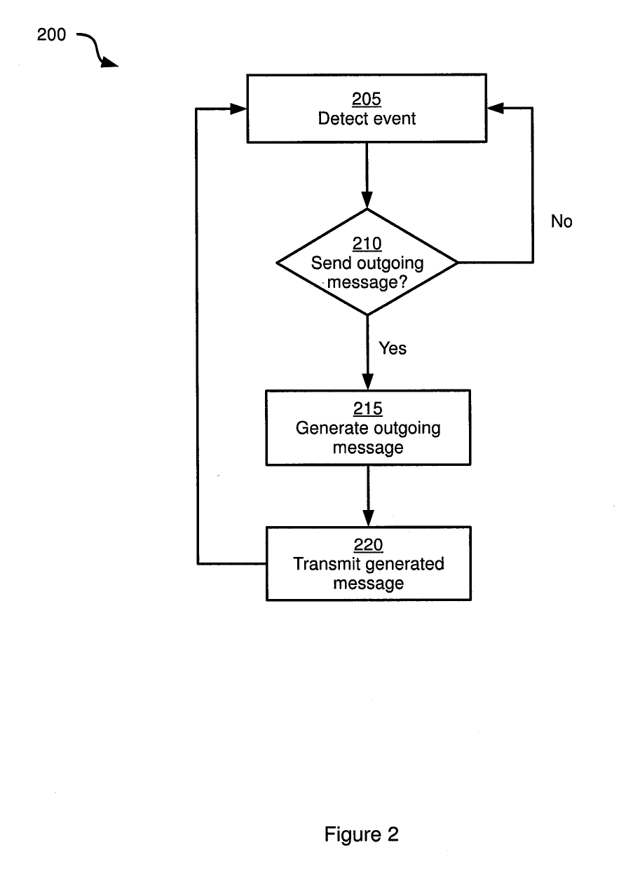

Turning now to FIG. 2, a method 200 for integrating warehouse and order management is shown, which server 104 is configured to perform via the execution of the computer readable instructions of application 119. Method 200 will be discussed below in conjunction with its performance in system 100. In the discussion below, server 104 is described as being configured to perform various actions. It is contemplated that server 104 is so configured as a result of processor 113 executing the instructions of application 119, making appropriate use of memory 114 and NIC 115.

At block 205, server 104 is configured to detect an event. A variety of events are contemplated. In general, an event is detected at server 104 as an update to data store 132, as a result of activities at production site 116 or messages received from either or both of servers 108 and 112. The nature of such an update is not particularly limited, and can include creation, deletion and editing (updating) of records in data store 132. The types of events detected at block 205 are not particularly limited, and can include messages received from server 112 defining orders for finished goods; updates to data store 132 reflecting transfers of inventory between site 116 and site 120, as well as transfers of inventory within a given site (for example, from a storage location at site 116 to production line 118); updates to data store 132 reflecting the conversion of subcomponents 124 into finished goods 128; and the like.

At block 210, server 104 is configured, in response to detecting the event at block 205, to determine whether to send at least one outgoing message to one or more of servers 108 and 112. The determination at block 210 is based on the nature of the event detected at block 205. When the determination at block 210 is negative, server 104 returns to block 205 to await the detection of a further event. When the determination at block 210 is affirmative, however, server 104 is configured to perform block 215.

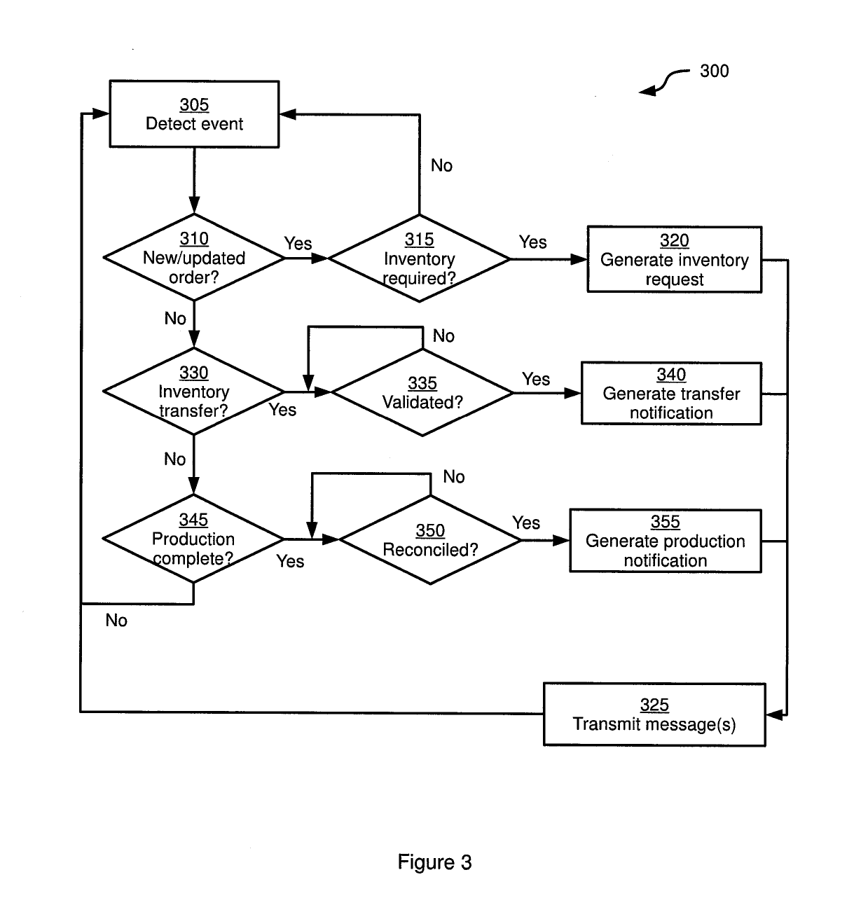

At block 215, server 104 is configured to generate an outgoing message destined to one or both of servers 108 and 112 and based on the nature of the event detected at block 205. At block 220, server 104 is configured to transmit the message or messages generated at block 215. In general, the messages transmitted at block 220 are for causing updates to one or both of data stores 136 and 140 that are necessitated by the update to data store 132 detected at block 205. The messages transmitted at block 220 can contain data for synchronizing data store 132 with portions of data stores 136 and 140 that overlap with data store 132. Specific examples of events and outgoing messages will be discussed below in connection with FIG. 3. Having sent the message or messages at block 220, server 104 is configured to await detection of another event, returning to block 205.

Turning now to FIG. 3, a method 300 for integrating warehouse and order management is shown, which server 104 is configured to perform via the execution of the computer readable instructions of application 119. Method 300 will be discussed below in conjunction with its performance in system 100.

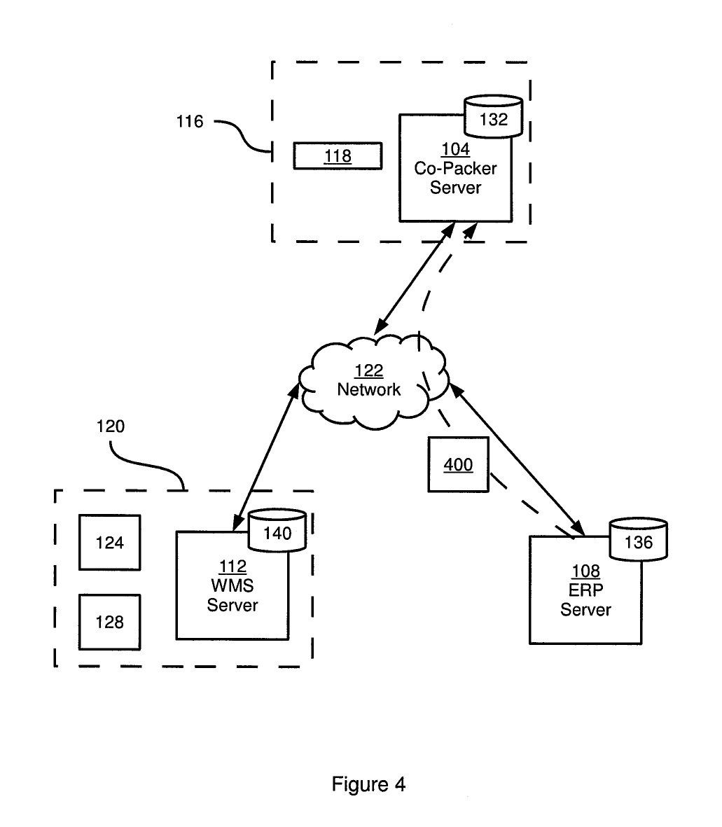

At block 305, server 104 is configured to detect an event, in the form of an update to data store 132. In the present example performance of method 300, the event detected at block 305 is the receipt of an order message from ERP server 108. The receipt of an order message 400 is shown in FIG. 4. In particular, order message 400 is generated at server 108 and sent via network 122, addressed to server 104.

Order message 400 is a request for a finished good 128. Order message 400 can therefore include various data, including an identifier of the finished good 128 to be produced at production site 116, the quantity of the finished good 128 to be produced, a date by which the finished goods are to be produced, a date the order was made (for example, the date message 400 was generated), a destination location for the finished goods (e.g. warehouse site 120), and the like.

It is contemplated that in some examples, the performance of block 305 can include conversion of message 400 from a first format to a second format prior to storage in data store 132. The first format is the format in which message 300 was generated, while the second format is a format that is compatible with data store 132 and the computer readable instructions executing at server 104. A wide variety of formats are contemplated, and the conversion at block 305 can be performed by selecting translation rules stored at server 104 based on, for example, a format identifier in message 400 (such as a software version).

Examples of formats that can be used for message 400 include XML, X12, GS1, JSON, CSV and the like. The transport used to deliver message 400 from server 108 to server 104 is also not particularly limited, and can include HTTP, HTTPS, AS2, AMQP, FTP and the like.

In some examples, the conversion mentioned above can be performed at a component other than server 104. For example, an additional conversion server (not shown) can be connected to server 104 via network 122, and message 400 can be delivered first to the conversion server, and then to server 104. In other examples, the conversion can be omitted altogether, such as when message 400 is compatible with data store 132 as generated (i.e. without conversion). For example, message 400 can be formatted according to an electronic data interchange (EDI) standard which both server 104 and server 108 are configured to interpret.

Having received message 400, server 104 stores the data contained in message in data store 132. For example, server 104 may be configured to automatically create a record defining a job based on the data contained in message 300, resulting in a change to data store 132. Thus, in the present example performance of method 300, the update to data store can be the creation of the data record shown in Table 2 based on message 400.

Following the detection of an event at block 205, server 104 is configured to determine a type of the detected event. Thus, at block 310, server 104 is configured to determine if the event is a new order (or an update to a previous order). In the present example performance of block 310, the determination is affirmative since, as noted above, message 400 is an order message resulting in the creation of a job record in data store 132. Server 104 is therefore configured to perform block 315, at which a determination is made as to whether the required subcomponents 124 for satisfying the order defined by message 400 are present and not already allocated to other jobs at site 116.

In the present example performance of method 300, it will be assumed that server 104 determines, from data store 132, that the required subcomponents are not present at site 116. The determination at block 315 is therefore affirmative, in that additional inventory is required to obtain the necessary subcomponents 124. Server 104 is therefore configured to proceed to block 320.

At block 320, server 104 is configured to automatically generate at least one message addressed to server 112, based on the event detected at block 305 and the determination at block 315. In the present example, server 104 is configured to generate a message to server 112 requesting a specified quantity of subcomponent 124, to be used at site 116 to fulfill the order defined by message 400. The message generated at block 320 comprises an inbound stock transfer order (ISTO), and thus includes identifiers of one or more subcomponents 124, a date on which the message was generated, a physical location to which the requested subcomponents are to be delivered (that is, site 116), and the like.

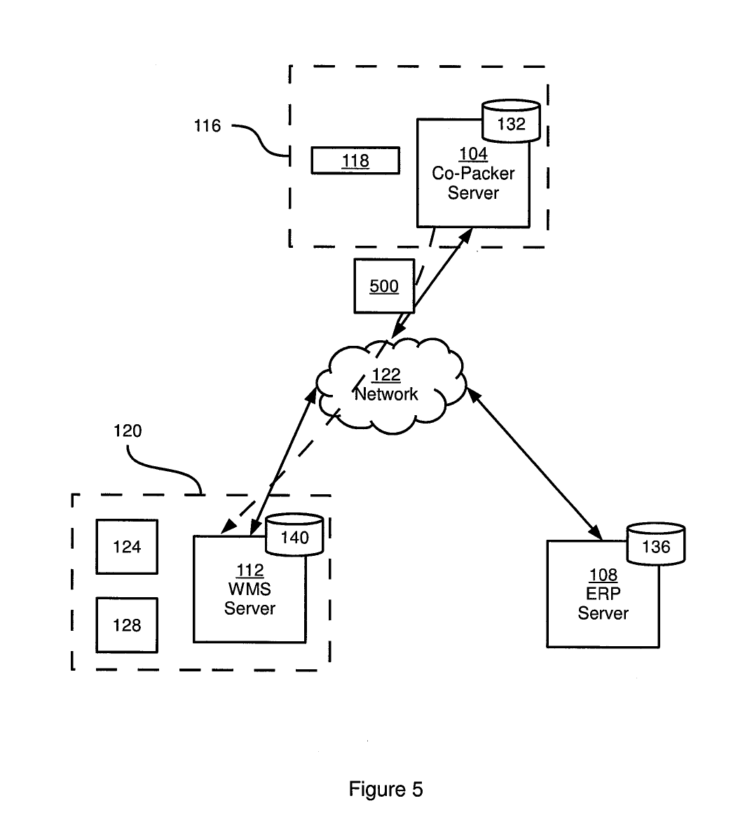

The performance of method 300 then proceeds to block 325, at which server 104 is configured to transmit the message generated at block 320. Turning to FIG. 5, a message 500 (the ISTO message described above) is shown being transmitted from server 104 to WMS server 112. As a result, message 500 is received at server 112 and a delivery of the requested subcomponents 124 is made to site 116.

Referring again to FIG. 3, following the performance of block 325, server 104 can be configured to return to block 305. In other words, the performance of method 300 can iterate. In addition, it is contemplated that multiple performances of method 300 can be performed substantially simultaneously, as server 104 may receive more than one order substantially simultaneously from server 108 (or from other enterprise management systems, not shown in FIG. 1).

Continuing with the above discussion, a second performance of method 300 will now be described, following from the first example performance. Thus, at block 305, server 104 is again configured to detect an event. In the present example of the second performance of method 300, the event detected at block 305 is the arrival of subcomponents 124 at site 116 from site 120, in response to the ISTO message 500 mentioned above. As a result of such arrival, data store 132 is updated to include data representing the movement of subcomponents 124 to site 116. The updated data can be automatically linked with the data in data store 132 defining the order received from server 108. For example, the update to data store can include the updating of the final row of Table 1 to replace the “Incoming” location identifier with a “Storage” location identifier.

Proceeding to block 310, server 104 is configured to determine whether the event is a new or updated order. In this example performance, the determination at block 310 is negative, and the performance of method 300 proceeds to block 330 At block 330, server 104 is configured to determine whether the event detected at block 305 comprises an inventory transfer event. The determination at block 330 is affirmative in the present performance of method 300, as inventory (subcomponent 124) has been transferred from warehouse site 120 to production site 116.

The event determined to be an inventory transfer event can take various forms. For example, upon delivery of subcomponents 124 to site 116, server 112 can be configured to transmit one or more inbound stock transfer (IST) messages to server 104 (for example, when a worker associated with warehouse site 120 scans each pallet of subcomponents 124 upon delivery to site 116). Each IST message received at server 104 is stored in data store 132 and detected as an event. An IST message can include, for example, a pallet identifier, a lot code and the like. When sites 116 and 120 are in the same facility, IST messages need not include destination identifiers such as those found in traditional shipping labels or bills of lading. Following physical delivery of subcomponents 124, a worker associated with site 116 can scan (or otherwise enter) data such as lot codes, pallet identifiers and the like for the delivered subcomponents using a computing device located at site 116 and connected to server 104 (via network 122 or via another network internal to site 116). The entered data is received and stored in data store 132, and therefore detected as an additional event. If the entered data matches the data of the IST message, the IST message is considered to have been “actualized” (that is, the physical delivery of subcomponents 124 is confirmed).

Following a “yes” determination at block 330, performance of method 300 proceeds to block 335. At block 335, server 104 is configured to determine whether a required validation activity has been performed as a precursor to any updates to data stores 136 and 140. In the present example, the event detected at block 305 is assumed to be the receipt of data at server 104 which actualizes one or more IST messages. For example, the ISTO message 500 may have requested five hundred units of subcomponent 124 and specified that the five hundred units have a certain range of expiry dates (for example, expiry dates at least 120 days in the future) or lot codes, but the subcomponents 124 physically received at site 116 may not satisfy the expiry date or lot code requirements of the ISTO. In such cases, corrective action may be required before notifying other entities (such as server 112) of the transfer. As another example, the ISTO message 500 can specify a certain range of lot codes or expiry dates, and also a sequence in which the subcomponents 124 having those lot codes or expiry dates are to be delivered for consumption (e.g. a “First Expiry First Out” sequence).

Therefore, as part of the performance of block 335, server 104 can be configured to determine whether the inventory transfer has been validated. Data store 132 can contain a flag in connection with the delivery of subcomponent 124 (e.g. as an additional field in Table 1) indicating whether or not such a validation has been completed. The validation flag can be examined by server 104 at block 335, and can be set as a result of input data received at server 104 from a user at site 116 (for example, a quality control worker physically inspecting the arrived subcomponents 124). Server 104 can also be configured to set the flag automatically. To that end, the determination at block 335 can include determining whether the subcomponents 124 received from warehouse site 120 match the above-mentioned sequence specified in ISTO message 500. In the case where the event detected at block 305 is the receipt of an IST message (instead of an actualization event) the determination at block 335 will typically be negative, as the validation activities described above generally do not take place until actualization of the IST message is complete (that is, until the physical arrival of subcomponents 124 at site 116 has been confirmed).

When the validation is not complete (that is, when the above-mentioned flag is negative and the determination at block 335 is therefore also negative), server 104 can repeat the performance of block 335, waiting for the validation to be completed. In other examples, server 104 can return to block 305, since the completion of the validation results in an update to the flag, which is detected as an additional event.

In the present example performance of method 300, it will be assumed that at the second pass of block 335, server 104 determines that the delivery of subcomponents 124 has been validated. The determination at block 335 is therefore affirmative, and the performance of method 300 proceeds to block 340.

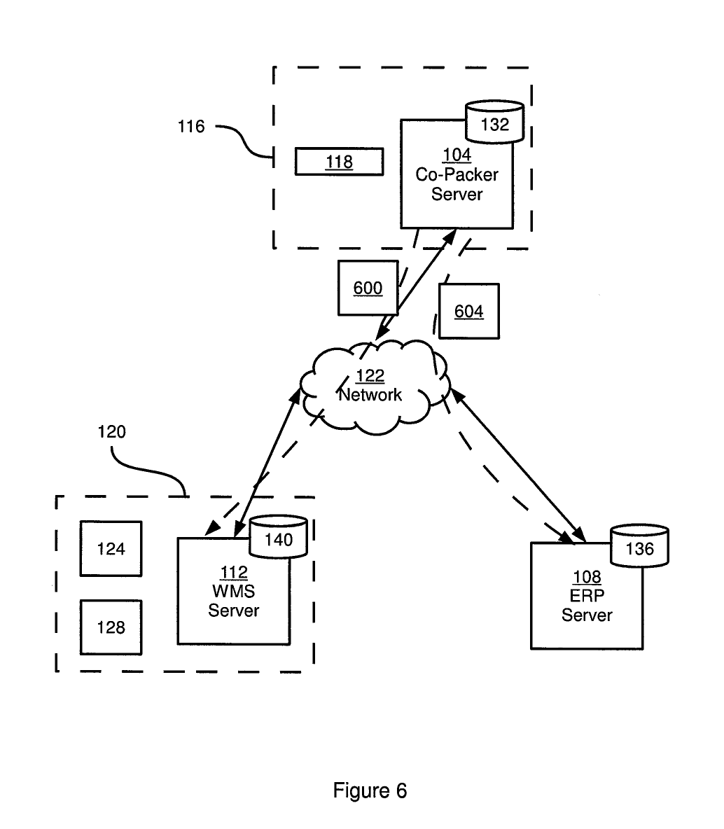

At block 340, server 104 is configured to generate at least one transfer notification message. In the present example performance of method 300, server 104 is configured to generate two messages at block 340: one addressed to server 108, and the other addressed to server 112. Both messages contain indications of the quantity of subcomponent 124 transferred from site 120 to site 116. Proceeding to block 325, server 104 is configured to transmit the messages generated at block 340, following any format conversion, if necessary. Turning to FIG. 6, an example performance of block 325 as described above is shown, in which a message 600 is sent to server 112, while a message 604 is sent to server 108. As a result of receiving messages 600 and 604, data stores 140 and 136, respectively, will be updated to reflect the transfer of subcomponents 124. Thus, referring to Table 3, the first and third records can be updated to reflect the new quantities of subcomponent 124 present at production site 116 and warehouse site 120.

It is contemplated that subsequent performances of method 300 can include the detection of events related to the movement of the newly arrived subcomponents 124 from storage at site 116 to production line 118. Such events are additional “inventory transfer” events, and can result in additional messages being transmitted to one or both of server 108 and server 112. For example, block 330 can be replaced with a plurality of determinations associated with additional types of events. For example, rather than a single inventory transfer event type, server 104 can be configured to detect two inventory transfer event types: the arrival or departure of inventory at or from site 116; and the movement of inventory within site 116. The second of these inventory transfer event types can result in a message being sent only to server 108, rather than to both servers 108 and 112.

A third example performance of method 300 will now be discussed, following the above performances. Server 104 is configured to detect another event at block 305. In this example performance, the event detected is an update to data store 132 showing conversion of subcomponents 124 to finished goods 128. For example, the second and third records of Table 1 can be updated to show a decrease in the quantity of subcomponent 124 at production line 118, and an increase in the quantity of finished good 128 at production line 118.

In this performance of method 300, the determinations at blocks 310 and 330 are negative, and server 104 is thus configured to perform the determination at block 345. If production is complete—that is, if the quantity of finished good 128 produced in connection with the job identifier 1234 equals or exceeds the quantity of finished good 128 specified by the corresponding job record in Table 2—server 104 proceeds to block 350. Otherwise, server 104 returns to block 305. It is contemplated that, at block 345, the determination can be whether a certain portion of a job is complete (for example, one pallet or other predetermined quantity of finished good 128), rather than the entire job.

In the present example performance, the determination at block 345 is complete, and server 104 therefore proceeds to block 350. At block 350, server 104 is configured to determine whether the production has been reconciled. Reconciliation is the correction of any discrepancies between the physical quantities of finished good 128 and of subcomponent 124 consumed, and the corresponding quantities stored in data store 132. Such discrepancies can occur, for example, due to breakage of subcomponents 124 during production. In such situations, data store 132 may not reflect the actual, physical quantities of subcomponent 124 and finished good 128 present at site 116. The job record can include a reconciliation flag which is set once reconciliation has been completed and any discrepancies corrected, and server 104 is therefore configured to examine the reconciliation flag at block 350.

If the determination at block 350 is negative (that is, reconciliation has not been performed), server 104 can return to repeat the performance of block 350, or can return to block 305. Assuming, however, that the determination at block 350 is affirmative, the performance of method 300 proceeds to block 355. At block 355, server 104 is configured to generate a production notification message addressed to server 112. The production notification message includes indications of the actual quantities of subcomponent 124 consumed and finished good 128 produced, the job identifier, the date, and the like.

It will now be apparent to those skilled in the art that additional performances of method 300 can include the detection of a further inventory transfer event representing the shipment of finished goods 128 back to warehouse site 120 following their production. Such a transfer is termed an outbound stock transfer (OST), and can result in the generation and transmission of an OST message to server 112, which can be actualized and validated at server 112, resulting in a confirmation message being received at server 104 confirming the inventory transfer.

Certain advantages will now occur to those skilled in the art, in light of the above discussion. For example, the need for communication between servers 108 and 112 can be reduced or eliminated without sacrificing the synchronization of the overlapping portions of data stores 132, 136 and 140. As a result, the need for modifications to servers 108 and 112 to allow such communication is reduced. Further, as the determinations and generations of messages discussed above are performed automatically based on the contents of data store 132, updates to data stores 136 and 140 can be provided substantially in real-time. Such timely updates can allow server 104, for example, to automatically issue a new ISTO message to server 112 following a determination that the remaining quantity of subcomponent 124 at site 116 is insufficient to complete a job currently being performed. An automatic ISTO may also be issued following a determination that the quantity of subcomponent 124 currently available at production line 118 will be consumed within a certain (configurable) time period, following which another quantity of subcomponent 124 will be required (e.g. for “just-in-time” production). In addition, server 104 can be configured to perform methods 200 and 300 to update a wide variety of data stores at other warehouse management or enterprise management systems such as those provided by servers 108 and 112.

Variations to the systems and methods described herein are contemplated. Each of servers 104, 108 and 112 can be operated by separate entities, or by the same entities. In other examples, servers 104 and 112 can be operated by the same entity. It is also contemplated that system 100 can include a plurality of additional WMS and ERP servers, and server 104 can be configured to transmit messages to any or all such servers during the performance of methods 200 and 300. As noted above, the automated updating provided by methods 200 and 300 can be used to maintain additional data stores in synchrony, even when large numbers of such data stores exist.

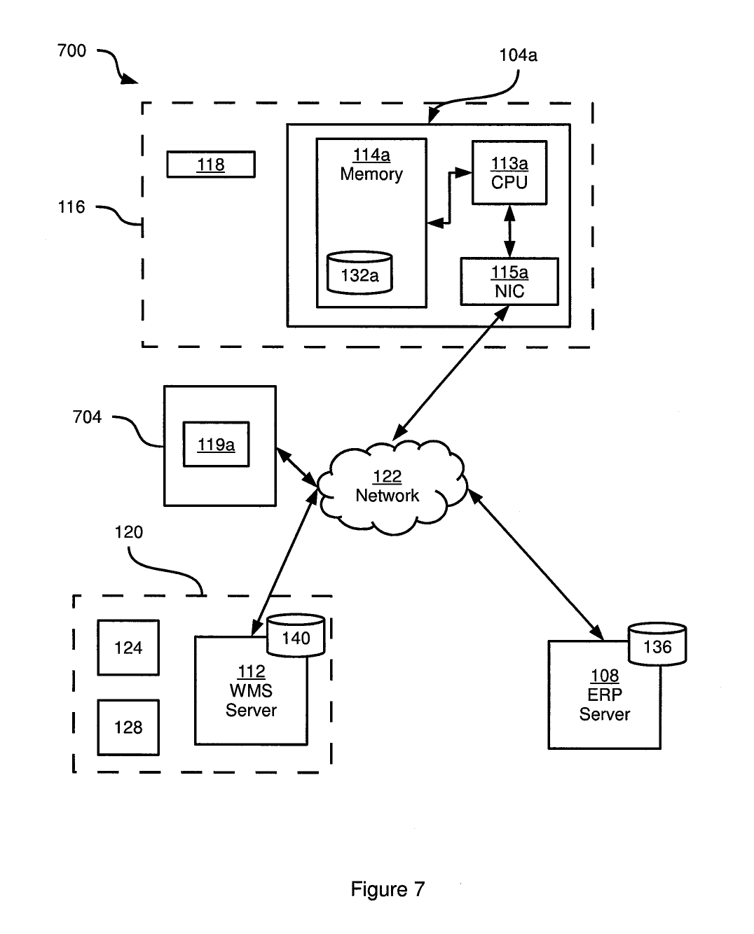

Referring to FIG. 7, a system 700 is shown which is a variation of system 100 as discussed above. System 700 includes a server 104a which is a modified version of server 104, in which application 119 is not present. System 700 also includes a common platform interface (CPI) server 704 provided with an application 119a in a memory thereof. Application 119a, when executed at server 704 (by a processor of server 704), provides the functionality described above in connection with server 104. Thus, servers 104a, 108 and 112 are configured to transmit messages representing events to server 704. Server 704 then performs a variation of method 300, in which messages can also be generated and sent to server 104a, in addition to servers 108 and 112. CPI server 704 can maintain a data store of its own, although this is not necessary.

In an additional variation, any one or combination of blocks 315, 335, and 350 can be omitted. For example, following an affirmative determination at block 345, server 104 (or server 104a) can be configured to automatically transmit a production notification message, whether or not reconciliation has been completed.

In other examples, servers 104 or 104a can also be configured to receive input data, for example from computing devices at production site 116 (such as a mobile device operated by a site worker), and in response to perform method 300. To that end, servers 104 and 104a can be configured to provide various interfaces for display at the computing devices (for example, in the form of web pages), for receiving input data. For example, a computing device can be used to cause the generation of an ISTO message similar to message 500, rather that such a message being generated in response to an affirmative determination at block 310.

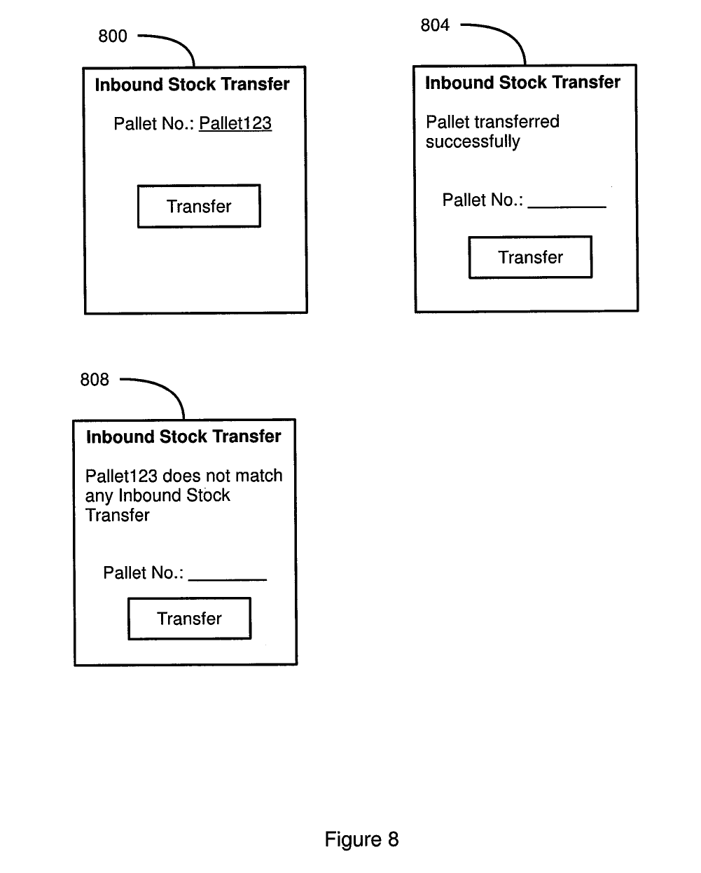

Examples of interfaces provided to computing devices are shown in FIG. 8. An interface 800 is provided to a computing device for entry or scanning of a pallet identifier or other data for a quantity of subcomponent 124 delivered to site 116. A field is included for entry of the data, and a selectable “Transfer” element, such as a virtual button, is included for transmitting the entered data to server 104. If the data matches a corresponding IST message stored in data store 132, an interface 804 is provided, including a notification that actualization was successful. If the entered data does not match any IST message, an interface 808 is provided, including a notification that actualization failed.

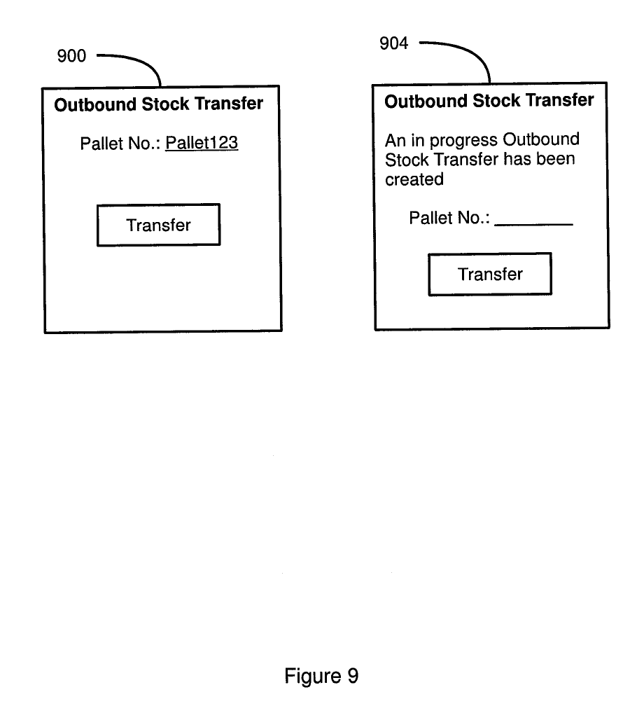

Turning to FIG. 9, interfaces 900 and 904 are shown. Interface 900 is provided to a computing device by server 104 for the entry of a pallet or other identifier of inventory (such as finished goods 128) to be shipped to warehouse site 120. Following the entry of an identifier and its transmission to server 104, interface 904 is provided, confirming that an OST message has been transmitted to server 112.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

We claim:

1. A method, comprising:
maintaining, in a memory connected to a first server, a first data store comprising a plurality of records representing one or more items at a production site;
detecting an event at the first server, the event comprising an update to the first data store;
in response to detecting the event, determining whether to send at least one outgoing message to one or more of a second server and a third server; and,
when the determination is affirmative, generating the outgoing message and transmitting the message to the one or more of the second server and the third server.

2. The method of claim 1, wherein the at least one outgoing message causes an update to a data store at the one or more of the second server and the third server.

3. The method of claim 2, wherein the first server is a contract packager server, the second server is an enterprise management server, and the third server is a warehouse management server.

4. The method of claim 1, wherein the update to the first data store comprises the storage of an order received from the second server for a specified quantity of a finished good item.

5. The method of claim 4, wherein the determination comprises determining whether sufficient subcomponent items are available to produce the specified quantity of the finished good item.

6. The method of claim 5, wherein, when the determination is negative, the outgoing message comprises a request for a determined quantity of subcomponent items.

7. The method of claim 1, wherein the update to the first data store comprises the storage of data representing an inventory transfer, and wherein the determination comprises determining whether the inventory transfer has been validated.

8. The method of claim 7, wherein the data representing the inventory transfer comprises a validation flag, and wherein the determination comprises examining the state of the validation flag.

9. The method of claim 1, wherein the update to the first data store comprises the storage of data representing the production of a finished good from at least one subcomponent, and wherein the determination comprises determining whether the production has been reconciled.

10. The method of claim 9, wherein the data representing the production comprises a reconciliation flag, and wherein the determination comprises examining the state of the reconciliation flag.

11. A server, comprising:
a processor; and
a network interface for connecting to a first data store comprising a plurality of records representing one or more items at a production site;
the processor configured to perform the method of claim 1.

12. A non-transitory computer-readable medium storing a plurality of computer-readable instructions executable by a processor, the computer-readable instructions for performing the method of claim 1.
